(19) United States
(12) Patent Application Publication
(10) Pub. No.: US 2012/0070808 A1
(43) Pub. Date: Mar. 22, 2012

(54) TEACHING SYSTEM COMBINING LIVE AND AUTOMATED INSTRUCTION

(76) Inventors: Michael Scott Fulkerson, Harrisonburg, VA (US); Andrew Harbick, Harrisonburg, VA (US); Charles "Alex" Herron, Waynesboro, VA (US); Alisha Huber, Dayton, VA (US); Ronald Bryce Inouve, Harrisonburg, VA (US); Gregory Keim, Broadway, VA (US); Anthony Lopez, Harrisonburg, VA (US); Jack August Marmorstein, Harrisonburg, VA (US); Christopher Spiller, Harrisonburg, VA (US); Alexandra Harper, Arlington, VA (US); Karl F. Ridgeway, Boulder, CO (US)

(21) Appl. No.: 12/887,618

(22) Filed: Sep. 22, 2010

(51) Int. Cl. G09B 19/06; G09B 5/00

(52) U.S. Cl. 434/157; 434/308

(57) ABSTRACT

Just prior to a scheduled session with a live instructor, a student is presented with an automated lesson which prepares him for the live instruction. The automatic lesson presents and practices skills that will be needed for the live lesson. Thus, when the instructor appears, the student is entirely prepared for the live lesson and optimum use may be made if the instructor's time. After the live lesson is complete, the student may be returned to an automated debriefing, which helps imprint major aspects of the live lesson of the students of mine. Thus, the learning process is improved through the combination of live and automatic instruction.

### BACKGROUND OF THE INVENTION

The present invention relates generally to teaching systems and, more particularly, concerns a teaching method and apparatus which combines live and automated instruction, to provide more effective teaching.

Automated instruction has become ubiquitous in the age of the personal computer. It offers the benefit of enabling the student to have a lesson at his convenience, to control the pace of a lesson, to repeat subject matter easily and without embarrassment, to avoid having to deal with an instructor he may find unpleasant, and best of all, it is relatively inexpensive, compared to the cost of a private lesson.

However, live instruction has its benefits. The instructor is often able to provide needed motivation, to focus more quickly on learning issues, and to vary the lesson more effectively, when needed to assist the student. In language study, for example, there is no substitute for hearing the language spoken properly or for carrying on a conversation interactively with a native speaker.

It is therefore desirable to include a certain amount of live instruction, and interaction with others in the teaching program. Live instruction may be provided in person by an instructor, but more often, would be undertaken in a live video connection between the instructor and student. In either case, the instructor's time is very valuable and must be used efficiently and effectively. Interaction with others may be interaction with other students or, for example in language study, a session to practice speaking the language with a native speaker.

In accordance with one aspect of the present invention, a teaching apparatus presents to a student an automated pre-lesson presenting instructive subject matter that prepares him for a learning interaction with another proximately in advance of the interaction. Preferably the interaction is a lesson to be presented by an instructor.

In accordance with a preferred embodiment, just prior to a scheduled session with a live instructor, a student is presented with an automated lesson which prepares him for the live instruction. The automatic lesson presents and practices skills that will be needed for the live lesson. Thus, when the instructor appears, the student is entirely prepared for the live lesson and optimum use may be made if the instructor's time. After the live lesson is complete, the student may be returned to an automated debriefing, which helps imprint major aspects of the live lesson of the students of mine. Thus, the learning process is improved through the combination of live and automatic instruction.

### BRIEF DESCRIPTION OF THE DRAWINGS

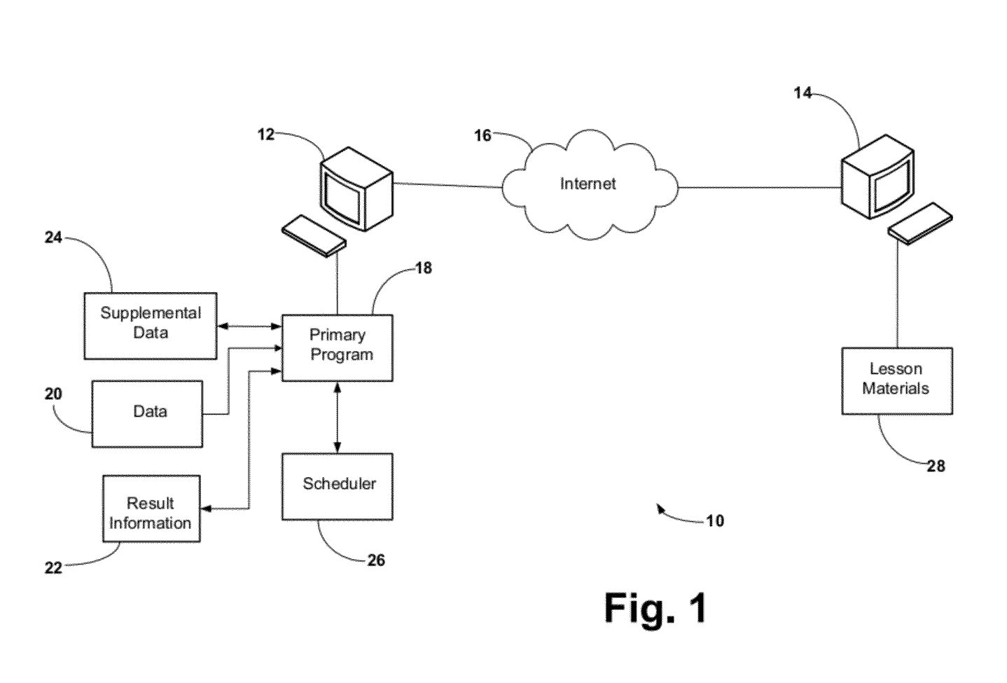

The foregoing brief description and for objects, features and advantages of the present invention will be understood more completely from the following detailed description of a presently preferred, but nonetheless illustrative, embodiment in accordance with the present invention, with reference being added to the accompanying drawing, in which FIG. 1, the only FIGURE, is a functional block diagram illustrating a presently preferred system 10 for combining live and automatic instruction which embodies the present invention.

### DETAILED DESCRIPTION OF THE PREFERRED EMBODIMENT

Turning now to the drawings, FIG. 1 is a functional block diagram illustrating a presently preferred system 10 for combining live and automatic instruction which embodies the present invention. A student terminal 12 and an instructor's terminal 14 are both connected to the Internet 16 so as to be able to communicate with each other. The student terminal 12 may be a personal computer with a display, a keyboard, a mouse, a video camera and audio pickup and playback, as well as other peripherals. The student terminal 12 is also running a primary program 18, which is a teaching program. For example, program 18 may be a language instruction program which has access to stored data 20, representing the entire information base for the program and it maintains result information 22, which includes a record of a student's progress in the learning program. Program 18 also has read/write access to supplemental data storage 24, and a scheduler 26, both of which are discussed further below.

The student may subscribe to an educational service from which he purchased the primary program 18. In conjunction with the studies offered by the primary program, the student may be entitled to periodic “live” lessons with an instructor. These may be intended to occur at certain portions of the teaching program, or they may supplement the teaching program. In this embodiment, the live lesson is a private lesson. However, it may be a group lesson, in which case several student terminals may connect with an instructor's terminal at the same time. In any event the private lesson represents an opportunity for students to interact with an instructor.

Using schedulers 26, the student will set up an appointment with an instructor for the private lesson. Program 18 will then take care of all the details of scheduling the lesson between the student and instructor. For the purposes of this disclosure, it is simply assumed that both the instructor and student have a specific appointment for a lesson.

The instructor's terminal 14 may be a personal computer with a display, a keyboard, a mouse, a video camera and audio pickup and playback, as well as other peripherals. Prior to a lesson, an instructor may request the student's result information 22 from the primary program 18, to help him customize the live lesson. On the other hand, the instructor's lesson may be a prepared lesson, with the interaction between him and the student being the customized portion. In any event, the instructor's terminal 14 stores lesson materials 28, which may include slides to be presented, photographs, graphics, music, video, materials extracted from prior lessons the student has taken, and prepared materials he has been provided. From his terminal, he is able to control what is being presented to the student during a lesson, whether it is the instructor's image from the video camera or selected items from lesson materials 28. Of course, he would also have the option of presenting audio or video to the student via the video camera. It is assumed that, at the time of the private lesson, primary program 18, under control of scheduler 26, will arrange for student terminal 12 and instructor's terminal 14 to communicate.

In the present embodiment, the instructor is presenting a live lesson that is scheduled into the curriculum of primary program 18. Accordingly, the subject matter of the live lesson is known ahead of time and is included within data 20. If the instructor wishes to present anything that is not included in data 20, he may, through program 18, provide additional information, which is then stored in supplemental data storage 24.

Scheduler 26 is constructed to alert the student at a predetermined time before the live lesson. It then presents a pre-lesson to the student. In the pre-lesson, the student is presented with subject matter that prepares him for and practices information to be presented during the live lesson. The pre-lesson may introduce materials from data 20 and supplemental data 24, and it is designed to coordinate with the live lesson. By design, the pre-lesson ends just as the live lesson is about to start, leaving the student primed for live learning.

Additionally, the system optionally sets up the order of the automated lessons in advance and in a manner to make the timing of the automated lesson that addresses the subject matter of the live instruction as close as possible to the live instruction. Hence, once the live lesson is scheduled by the system and/or the student at a particular time, the system then examines set of automated lessons and orders them in a manner that is dependent upon one or both of 1) the subject matter of the live instruction, and 2) the timing selected or set by the system for the live instruction, thereby optimizing the chance that an automated lesson directed to the same subject matter as the live lesson will occur as close as possible in time to the live instruction.

At the conclusion of the live lesson, scheduler 26 may cause the presentation of a post-lesson, which basically debriefs the student. At this point, key elements from the live lesson may be presented, to ensure that the student will retain them.

It is contemplated that, instead of being presented in advance of a live lesson, a pre-lesson could be presented to prepare a student in advance of an interaction with one or more other students, or others. For example, language students could be carrying on a group conversation in a foreign language or a language student could be carrying on a conversation with another who is a native speaker of the language.

In an enhanced embodiment, the system may optimize the live portion of the instruction when a group of students is to participate in the same live instruction session. Specifically, each student in the group may be at different levels of knowledge and skill with respect to the skill set required for the live instruction. The system may then adjust the individual automated portions of the learning lessons of each of the individuals to participate in the live class. In this manner, the learning pace and subject matter from each individualized lesson may be sped up or slowed down, in order to attempt to optimize the chance that all of the students to participate in the live instruction are synchronized with respect to their preparedness from the live less.

In furtherance of the above, the system may store an automated lesson plan for each of the plurality of students. However, before loading and implementing such lesson plan to execute it when the student logs on, the system optionally checks if the student is to participate in a live session. The system then adjusts the lesson plan of all the students to participate in a common live session to better synchronize their knowledge of the subject matter. Such adjustments may be different for each of the different students.

Although a preferred embodiment of the invention has been disclosed for illustrative purposes, those skilled in the art will appreciate that many additions, modifications, and substitutions are possible without departing from the scope and spirit of the invention as defined by the accompanying claims.

What is claimed:

1. A teaching method, comprising the step of, through a computerized teaching apparatus and proximately in advance of an interaction of a student with another, presenting to the student an automated pre-lesson presenting instructive subject matter that prepares him for the interaction.

2. The method of claim 1 further comprising the step of actuating the interaction after completion of the pre-lesson.

3. The method of claim 2 further comprising the step of, upon completion of the interaction, presenting an automated post-lesson presenting instructive subject matter related to the interaction.

4. The method of claim 3 wherein the interaction is a lesson presented by an instructor, the pre-lesson prepares the student for the instructor's lesson and the post lesson is designed to impress primary aspects of the instructor's lesson upon the student.

5. The method of claim 4 wherein the instructor's lesson is a language lesson.

6. The method of claim 1 wherein the interaction is a lesson presented by an instructor and the pre-lesson prepares the student for the instructor's lesson.

7. The method of claim 6 wherein the instructor's lesson is a language lesson.

8. The method of claim 1 wherein the interaction is an interaction with another student related to subject matter they are both studying.

9. The method of claim 8 wherein the students are both studying a foreign language.

10. The method of claim 1 wherein the student is studying a foreign language and the interaction is a session practicing speaking the language with a native speaker thereof.

11. A computerized teaching apparatus including a display and audio presentation means for a student and comprising means for presenting to the student on the presentation means an automated pre-lesson including instructive subject matter that prepares him for an interaction with another proximately in advance of the interaction.

12. The apparatus of claim 11, further comprising means for actuating the interaction after completion of the pre-lesson.

13. The apparatus of claim 12 further comprising means for presenting an automated post-lesson presenting instructive subject matter related to the interaction.

14. The apparatus of claim 13 wherein the interaction is a lesson presented by an instructor, the pre-lesson prepares the student for the instructor's lesson and the post lesson is designed to impress primary aspects of the instructor's lesson upon the student.

15. The apparatus of claim 14 wherein the instructor's lesson is a language lesson.

16. The apparatus of claim 11 wherein the interaction is a lesson presented by an instructor and the pre-lesson prepares the student for the instructor's lesson.

17. The apparatus of claim 16 wherein the instructor's lesson is a language lesson.

18. The apparatus of claim 11 wherein the interaction is an interaction with another student related to subject matter they are both studying.

19. The apparatus of claim 18 wherein the subject matter is a foreign language.

20. The apparatus of claim 11 wherein the student is studying a foreign language and the interaction is a session practicing speaking the language with a native speaker thereof.

21. A computerized teaching system comprising a plurality of automated lessons directed to a student, software for allowing selection by the system or the student of a time and subject matter of a live instruction lesson, and software for automatically, and in response to said selection, determining an order in which said automated lessons are to be executed.

22. The computerized teaching system of claim 21 wherein said teaching system is for language learning, and said automated lessons display images.

23. The computerized system of claim 21 wherein the system includes software to ascertain all of said participants in a specific live session, and for independently adjusting automated lessons presented to one or more of said participants to synchronize said participants' skills related to said live session.
